(19) United States
(12) Patent Application Publication
(10) Pub. No.: US 2003/0223032 A1
(43) Pub. Date: Dec. 4, 2003

(54) Eyewear and system

(76) Inventors: Mario Gagnon, Montreal (CA); Brent Sheldon, Montreal (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/448,384

(22) Filed: May 30, 2003

Related U.S. Application Data
(60) Provisional application No. 60/445,449, filed on Feb. 7, 2003.

(30) Foreign Application Priority Data
May 30, 2002 (CA) 2,388,293

(51) Int. Cl. G02C 1/00; G02C 1/08

(52) U.S. Cl. 351/92

(57) ABSTRACT

An eyewear system, includes: at least one pair of lenses; an eyewear frame including a pair of lens frames, the lens frames connected by a bridge, each lens frame releasably holding a corresponding lens of the at least one pair of lenses; a locking element for clamping the bridge of the eyewear frame and preventing the lens frames from releasing the held lenses; the locking element having a “C” shaped cross-section, the locking element including a planar main portion, an upper portion relatively proximate to the nosepiece of the eyewear and a lower portion relatively distant from the nosepiece, the upper and lower portions attached at substantially right angles to the main portion, a descending upper flange attached to the upper portion and a rising lower flange attached to the lower portion, and a tab provided on the rising lower flange, the tab protruding from the plane of the rising lower flange and extending away from the main portion, the tab serving as a grip for manual manipulation of the locking element by the user and serving as a lever when removing the locking element from the eyewear frame by rotating the locking element about the upper portion; at least one side support for holding the eyewear frame to a head of the user; releasable mounting means for mounting the at least one side support to the eyewear frame; and a nosepiece mounted to the frame for spacing the eyewear frame from a face of the user.

### CROSS-REFERENCE TO RELATED APPLICATIONS

The present application claims the benefit of convention priority from Canadian Patent Application No. 2,388,293 entitled “EYEWEAR AND SYSTEM” filed on May 30, 2002, the entirety of which is hereby incorporated by reference. The present application is related to U.S. Provisional Patent Application No. 60/445,449 filed on Feb. 7, 2003.

### FIELD OF THE INVENTION

The present invention relates to eyewear and particularly, to a system of eyewear having a number of different features including adjustable arms and interchangeable lenses.

### BACKGROUND OF THE INVENTION

Conventional eyewear, such as sunglasses, have a number of drawbacks. For example, the arms are typically a single moulded piece that is not easily adjustable. A conventional ear support for a pair of eyeglasses is formed as a one-piece ear stem, the length of which is fixed. If the length of the ear support is not proper, one might feel uncomfortable wearing the eyeglasses. Particularly, a smaller length can cause aching of the user's ears, while a longer length can hinder the lens frame from being properly seated on the user's nose. Furthermore, lenses are typically mounted in a fashion that makes it difficult to change them. Although conventional sunglasses may be suitable for use at the beach, they may not be suitable for all events, such as social occasions.

Accordingly, it is desirable to be able to modify eyewear to suit different environments. To do so conveniently requires that fragile or delicate components such as lenses be readily available for use when desired and protected and accessible when stored. Furthermore, existing mechanisms for changing lenses can be awkward due to relatively large forces required to remove locking mechanisms. The small size of the parts involved can also make it difficult for the user maintain the necessary grip to perform the lens changing operation comfortably.

### SUMMARY OF THE INVENTION

It is an object of the present invention to obviate or mitigate at least one problem associated with the prior art.

According to an aspect of the present invention, an eyewear system, includes: at least one pair of lenses; an eyewear frame including a pair of lens frames, the lens frames connected by a bridge, each lens frame releasably holding a corresponding lens of the at least one pair of lenses; a locking element for clamping the bridge of the eyewear frame and preventing the lens frames from releasing the held lenses; the locking element having a “C” shaped cross-section, the locking element including a planar main portion, an upper portion relatively proximate to the nosepiece of the eyewear and a lower portion relatively distant from the nosepiece, the upper and lower portions attached at substantially right angles to the main portion, a descending upper flange attached to the upper portion and a rising lower flange attached to the lower portion, and a tab provided on the rising lower flange, the tab protruding from the plane of the rising lower flange and extending away from the main portion, the tab serving as a grip for manual manipulation of the locking element by the user and serving as a lever when removing the locking element from the eyewear frame by rotating the locking element about the upper portion; at least one side support for holding the eyewear frame to a head of the user; releasable mounting means for mounting the at least one side support to the eyewear frame; and a nosepiece mounted to the frame for spacing the eyewear frame from a face of the user.

In order to organize and store the components of an eyewear system, it is desirable to have a carrying case capable of protecting the components of the system while not in use yet compact enough to allow it to be easily carried by the user. In addition, the system includes different lenses for use in different environments or while performing different activities. For example, Light Equalization System lenses can be used to eliminate up to 100% of harmful UV-A and UV-B light rays. They self-calibrate light frequencies to provide a crisp contrast and sharp definition. The top surface hard coat is scratch resistant. By contrast the limiter lenses are very dark lenses for exceptionally sunny days. The enhancer lenses are high-contrast lenses for dull, cloudy or hazy days.

To allow for easier removal of side supports, namely the microslot arms, sport arms or headband from the eyewear frame and replacement of another one, an “S” shaped complementary coupling member is provided on the side supports having planar sidewalls for engagement with a corresponding hollow in coupling members attached to the eyewear frame. The smooth featureless sidewalls of the complementary coupling member allows easier removal of side supports compared with the prior art which included a retaining shoulder or other locking mechanisms which made it difficult to remove side supports.

Advantageously, the eyewear system is more accessible, better organized and more portable due to the inclusion of the carrying case. The delicate items such as lenses are securely stored safe from scratches and breakage. Furthermore, changing the lenses is greatly facilitated by use of the tab on the vise-lock lens transfer element.

### BRIEF DESCRIPTION OF THE DRAWINGS

The features and advantages of the present invention will be described in more detail with reference to the accompanying drawings which illustrate the preferred embodiments of this invention, wherein:

FIG. 1 is an exploded perspective view of a pair of eyeglasses in the first embodiment of this invention;

FIG. 2 is an assembled perspective view of the eyeglasses in FIG. 1, with an impact cushioning band detached from the lens frame;

FIG. 3a is a front plan view of the eyeglasses in FIG. 2 with the impact cushioning band removed therefrom for clarity;

FIG. 3b is a side view of the eyeglasses shown in FIG. 3a;

FIG. 4a is a partly schematic cross-sectional view taken along line B-B of FIG. 3a, where the lens receiving spaces are in a smaller-sized contracted state;

FIG. 4b is a view similar to FIG. 4a except that the lens receiving spaces are in a larger-sized normal state;

FIG. 5a is a partly schematic cross-sectional view taken along line A-A of FIG. 3a;

FIG. 5b is an exploded view of FIG. 5a;

FIG. 6 is a is a perspective view of a coupling member mounted on the right side of the lens frame; FIG. 6b is a bottom view of the coupling member shown in FIG. 6a;

FIG. 7a is a partly schematic cross-sectional view taken along line C-C of FIG. 3a, showing the engagement between the coupling member and the respective one of the lens retaining rims 10 at a section where a projection is provided;

FIG. 7b is a partly schematic cross-sectional view taken along line D-D of FIG. 3a, showing the engagement between the coupling member and the respective lens retaining rim;

FIGS. 8a and 8b illustrate the “S”-lock complementary coupling member according to the present invention;

FIG. 9 is a perspective view of the right side ear stem;

FIG. 10a is an assembled schematic side view of an ear stem and an earpiece;

FIG. 10b is a view similar to FIG. 10a, but with the earpiece being shown in cross section;

FIGS. 11a and 11b are perspective views of an earpiece and FIG. 11c is a rear view of the earpiece;

FIGS. 12a and 12b are cross-sectional views taken along lines E-E and F-F in FIG. 10a, respectively;

FIG. 13 is a partly schematic side view of an earpiece and an ear stem, showing the earpiece in a position for adjustment;

FIG. 14 is a perspective view of the eyeglasses of this invention, wherein the first stem-type side support is replaced by the second strap-type side support;

FIGS. 15a and 15b are perspective views of a right side strap fastener of the second strap- type side support;

FIG. 16a is a top view of a lens;

FIG. 16b is a partly schematic cross-sectional view showing the engagement between one of the lenses and the respective one of the lens retaining rims;

FIG. 17 is a perspective view of a cushioning band;

FIG. 18 is a front plan view of a pair of eyeglasses in a second embodiment of this invention, where a cushioning band is removed for clarity;

FIG. 19 is a partly schematic cross-sectional view taken along line G-G in FIG. 18;

FIG. 20 is a perspective view of a carrying case according to another aspect of the present invention;

FIG. 21 is a plan view of the carrying case of FIG. 20;

FIG. 22 is a front elevation view of the carrying case of FIG. 20;

FIG. 23 is a right side elevation view of the carrying case of FIG. 20;

FIG. 24 is a left side elevation view of the carrying case of FIG. 20;

FIGS. 25a, 25b and 25c illustrate front, side and bottom views of a vise-lock lens transfer element according to the present invention;

FIGS. 26a, 26b and 26c illustrate front, bottom and enlarged views of a lens adaptor included in the present invention;

FIGS. 27 to 36 illustrate changing the lenses of the present invention;

FIGS. 37 to 42 illustrate changing the arm and headband of the present invention;

FIGS. 43 to 46 illustrate adjusting the microslot arms;

FIGS. 47 to 49 illustrate installing the sport visor;

FIG. 50 illustrates cleaning the lenses;

FIGS. 51 to 52 illustrate installing the optical adaptor;

FIGS. 53 and 54 illustrate the attachment of the optical adaptor to the eyewear in sectional view; and

FIGS. 55 and 56 illustrate the attachment of the optical adaptor to the eyewear.

### DETAILED DESCRIPTION

Generally, the present invention relates to a system of eyewear having numerous features and advantages as described below and illustrated in the drawings.

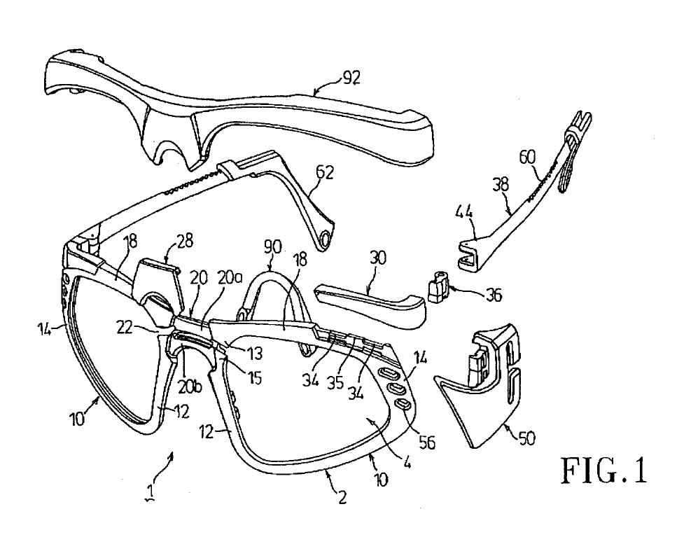

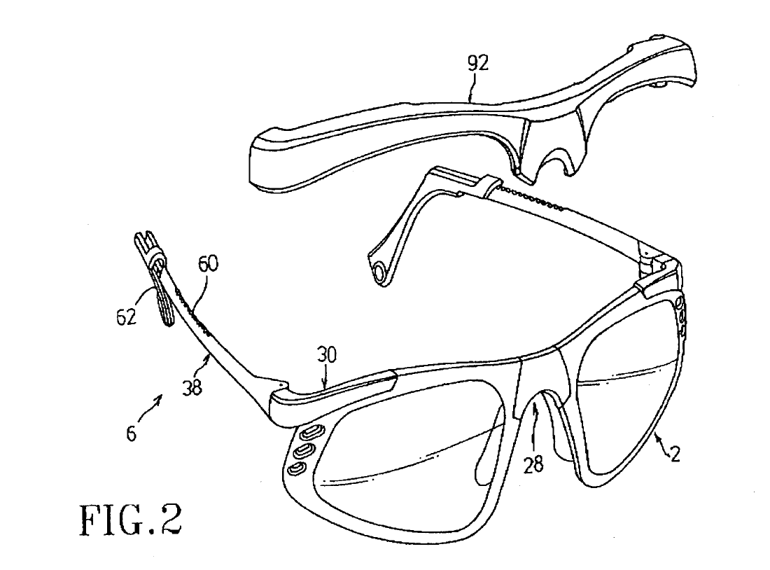

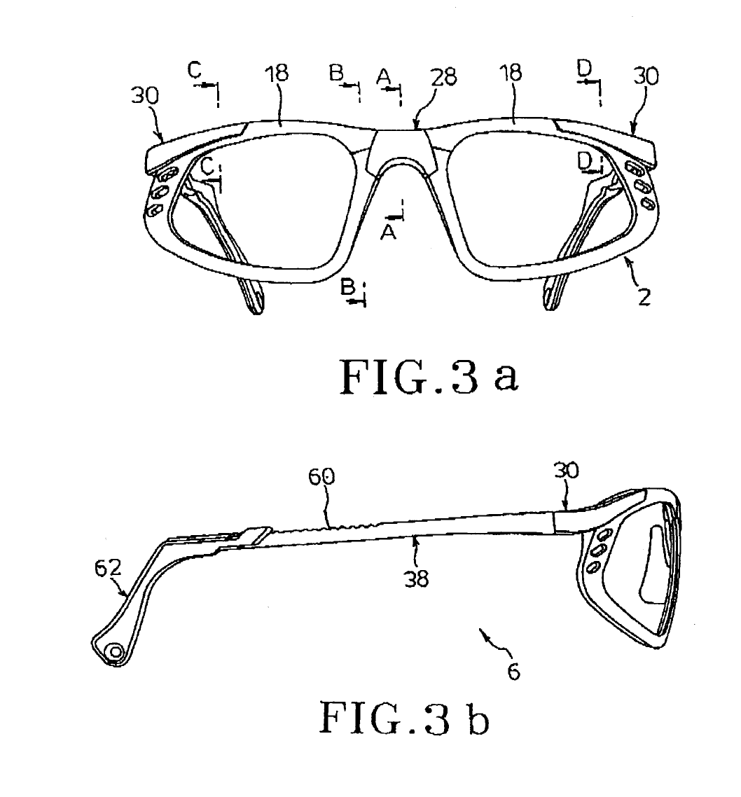

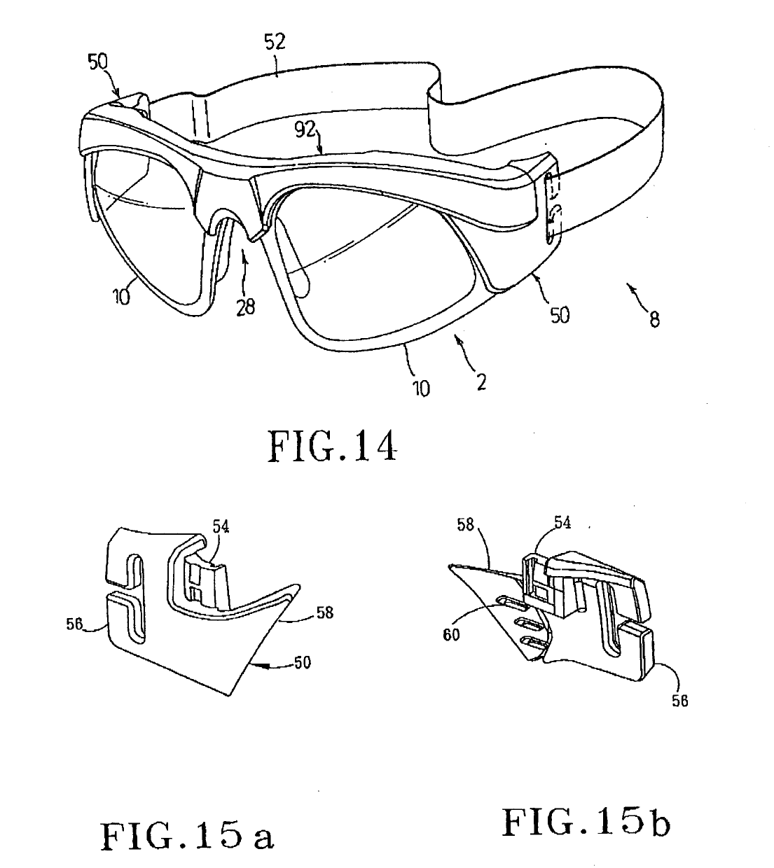

Referring to FIGS. 1 to 3, a pair of eyeglasses 1 of a first preferred embodiment of this is shown to include a lens frame 2, a pair of lenses 4 mounted onto the lens frame 2, and a side support including a first side support G and a second side support 8 (see FIG. 14) The first side support 6 is of a type that includes a pair of ear stems as shown in FIG. 2, while the second side support 8 is of a type that includes a strap, as shown in FIG. 14. The first side support 6 and the second side support B are interchangeable to meet different needs.

The lens frame 2 which is formed integrally and made from a resilient material, such as plastic or polycarbonate, has a pair of lens retaining rims 10 that are spaced apart in a first direction on a plane of the lens frame 2. Each of the lens retaining rims 10 has an inner lateral rim portion 12, an outer lateral rim portion 14, and an upper rim portion 18 connecting the lateral rim portions 12, 14. The inner lateral rim portions 12 of the lens retaining rims 10 are disposed adjacent to each other. A bridge 20 extends in the first direction and interconnects the inner lateral rim portions 12 of the lens retaining rims. Preferably, the front side of 2 the bridge 20 is recessed with respect to front sides of the lens retaining rims 10. Each of the lens retaining rims 10 further has a lens engaging inner periphery that confines a lens receiving space for receiving one of the lenses 4 therein.

A lens removing slit 22 is formed to communicate the two lens receiving spaces formed by the lens retaining rims 10. The lens removing slit 22 extends from the lens engaging inner periphery of one of the lens retaining rims 10, through the inner lateral rim portion 12 of said one of the lens retaining rims 10 through the bridge 20, and through the inner lateral rim portion 12 and the lens engaging inner periphery of the other one of the lens retaining rims 10. The lens removing slit 22 divides each of the inner lateral rim portions 12 into an upper and a lower section 13, 15, and divides the bridge 20 into an upper and a lower section 20a, 20b. The upper section 13 and the lower section 15 of each of the inner lateral rim portions 12, and the upper section 20a and the lower section 20b of the bridge 20 are normally spaced apart in a second direction transverse to the first direction.

The lens receiving spaces formed in the lens retaining rims 10 suitably contain the lenses 4 therein such that the lens engaging inner 2 periphery of each of the lens retaining rims 10 engages fittingly the outer periphery the respective one of the lenses 4. The lens receiving spaces can be adjusted by forcing the upper section 20a and the lower section 20b of the bridge 20, as well as the upper sections 13 and the lower sections 15 of the inner lateral rim portions 12 toward each other so as to change the lens receiving spaces from a larger-sized normal state to a smaller-sized contracted state.

In the larger-sized normal state where the lens receiving spaces are larger in size than the lenses 4 to be inserted, the lenses 4 can be inserted easily into the lens receiving spaces and engage the periphery of a respective one of the lens retaining rims 10. Once the lenses 4 are retained in position, the upper section 20a and the lower section 20b of the bridge 20 and the upper sections 13 and the lower sections 15 of the inner lateral rim portions 12 are forced together so as to change the lens receiving spaces into the smaller-sized contracted state, where the lenses 4 are firmly clamped by the inner periphery of the respective one of the lens retaining rims 10.

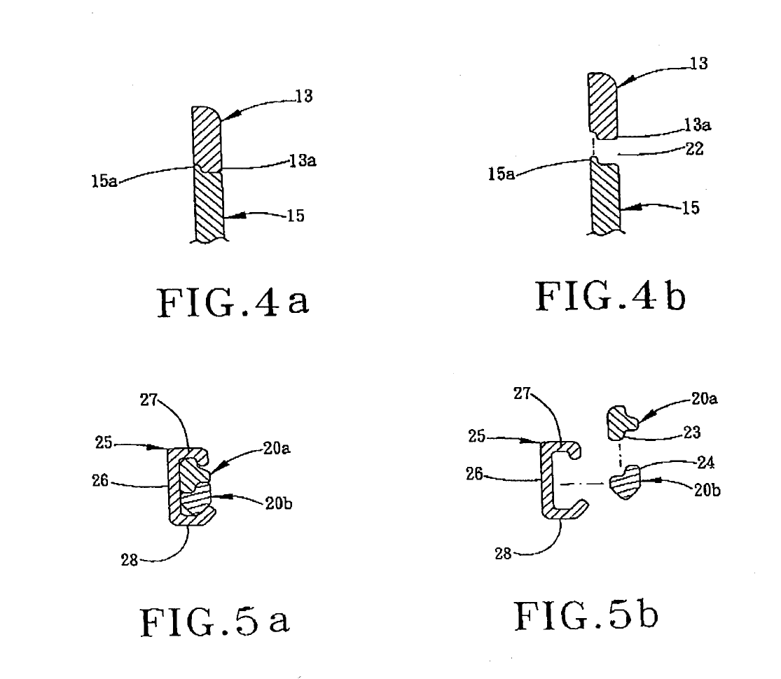

Referring to FIGS. 4a and 4b, in the larger-sized normal state, the upper and lower sections 13, 15 of the inner lateral rim portions 12 are spaced apart by the lens removing slit 22. The upper and lower sections 13, 15 of the inner lateral rim portions 12 have confronting surfaces which are preferably formed with complementary abutment projections 13a and 1a, respectively that are staggered relative to each other in a third direction transverse to the first and second directions. When the upper and lower sections 13, 15 are brought into contact to change the lens receiving spaces into the smaller-sized contracted state, the confronting surfaces of the upper and lower sections 13,15 abut fittingly against each other in the third direction.

Referring to FIGS. 5a and 5b, the upper and lower sections 20a, 20b of the bridge 20 are shown in an assembled and an exploded view, respectively. As with the upper and lower sections 13, 15 of the inner lateral rim portions 12, the upper and lower sections 20a, 20b also have confronting surfaces which are preferably formed with complementary abutment projections 23, 24. However, the complementary abutment projections 23, 24 of the bridge 20 are not provided at the same side as the abutment projections 13a, 15a of the inner lateral rims 10 12. More specifically, the abutment projections 13a of the upper sections 13 are at the right side as viewed in FIGS. 4a and 4b, while the abutment projection 23 of the upper section 20a of the bridge 20 is at the left side thereof, as viewed in FIGS. 5a and 5b. Accordingly, the abutment projections 15a of the lower sections 15 are at the left side thereof, as viewed in FIGS. 4a and 4b, while the projection 24 of the lower section 20b of the bridge 20 is formed at the right side thereof. With such an arrangement, the shearing which occurs between the confronting surfaces of the upper and lower sections 13, 15 will be strictly prevented. For instance, the movement of an upper section 20a of the bridge 20 by a shearing force applied in the direction normal to the lenses 4 will be constrained by either the lower section 20b of the bridge 20 or by the lower section 15 of the inner lateral rim portions 12, depending on which direction the shearing force is applied.

To bring the upper and lower sections 20&, 20b of the bridge 20 and the upper and lower sections 13,15 of the inner lateral rim portions 12 into contact, a fastener 25 is mounted onto the bridge 20 for flanking the upper and lower sections 20a, 20b of the bridge 20 and for clamping the same together. As shown in FIGS. 5a and 5b, the fastener 25 includes a front plate portion 26 to be disposed on a front side of the bridge 20, an upper hooking portion 27 extending rearwardly from a top edge of the front plate portion 26 for hooking with the bridge 20 at a rear side of the upper section 20a of the bridge 20, and a lower hooking portion extending rearwardly from a bottom edge of the front plate portion 26 for hooking with the bridge 20 at a rear Bide of the lower section 20b of the bridge 20. The upper and lower hooking portions 27, 28 flank the upper and lower section 20a, 20b of the bridge 20 therebetween. The upper hooking portion 27 has a bent distal end that extends downwardly, and the lower hooking portion 28 has a bent distal end that extends upwardly.

The lower section 20b of the bridge 20 has a tapering lower part formed with inclined front and rear guide surfaces to guide engagement and disengagement between the lower hooking portion 28 and the lower section 20b of the bridge 20.

Preferably, the fastener 25 is formed integrally from a resilient material, such as polycarbonate or nylon zytel, to facilitate the mounting of the fastener 25 onto the bridge 20. Further, as shown in FIG. 2, since the front side of the bridge 20 is recessed with respect to the front sides of the lens retaining rims 10, when the fastener 25 is mounted on the bridge 20, the front plate portion 26 of the fastener 25 is substantially flush with the front sides of the lens retaining rims 10 to provide an integral appearance.

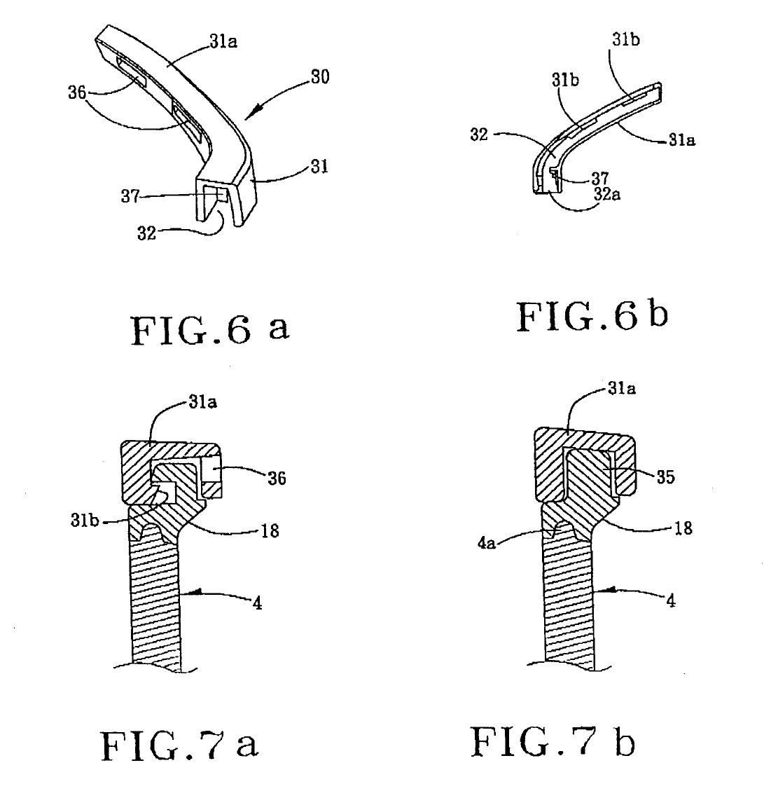

A pair of hollow engaging parts is provided on the lens receiving rims 10 for connecting the first side support 6 onto the lens receiving rims 10. In this embodiment, the hollow engaging parts are formed on a pair of coupling members 30 which can be mounted detachably on the upper rim portions 18 of the lens retaining rims 10. As shown in FIGS. 6a and 6b, each of the hollow engaging parts 31 of the coupling members 30 extends rearwardly to confine an engaging space 32. An opening 32a is formed in each of the engaging parts 31 to provide an access to the engaging space 32. Each of the hollow engaging parts 31 is disposed adjacent to the outer lateral rim portion 14 of the respective one of the lens retaining rims 10 for connecting with the first side support 6.

As clearly shown in FIGS. 6a and 6b, each of the coupling members 30 further has a hollow mounting part 31a which has an open bottom side formed with at least one projection 31b. Referring to FIG. 7a in conjunction with FIG. 1, hook retainers 34 which extend upwardly are formed on the upper rim portions 18 of the lens retaining rims 10 for snap-fitting within the respective mounting part 31a at a section where a projection 31b is provided. As to the remaining sections of the mounting part 31a where the projections 31a are not provided, the remaining parts 35 formed on the upper rim portions 18 may be fittingly inserted into the space defined by the mounting part 31a, as shown in FIG. 7b. On the vertical walls of the mounting part 31a adjacent to the projections 31b, through holes 36 may be provided to increase the flexibility of the engaging part 31.

The engaging part 31 further includes a locking rib 37 extending into the engaging space 32 for locking with the first side support 6, which will be described hereinafter.

Preferably, each of the coupling members 30 is made from a resilient material, such as nylon zytel, and has a front side that is substantially flush with front sides of the lens retaining rims 10 when the coupling members 30 are mounted thereon in order to provide an integral appearance, as shown in FIG. 2.

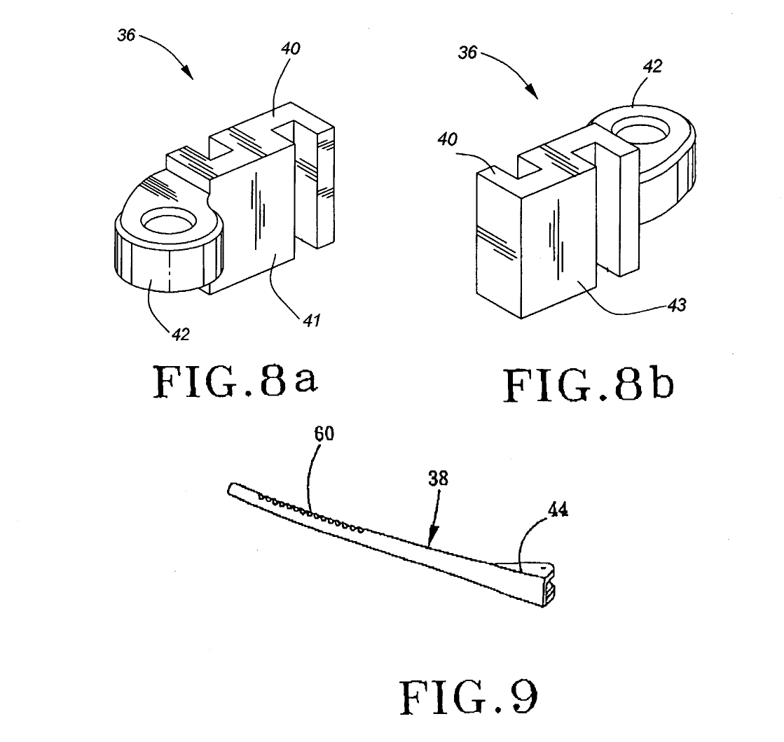

Referring back to FIG. 1, the first side support 6 includes a pair of hinge members 36 and a pair of ear stems 38. Referring to FIGS. 6a, 6b, 7a, 7b, 8a and 8b, the eyewear frame is provided with a pair of coupling members 30, each coupling member having an engaging space 32 having planar sidewalls, elongate ribs 37 provided on the planar sidewalls to define an “S”-shaped hollow in each coupling member. The side supports, such as microslot arms have “S”-shaped complementary coupling members 40a connecting element, such as on the hinge members 36 in the example of an arm or a corresponding member in a headband. The complementary coupling members have planar sidewalls 41, 43 for frictional engagement with the “S”-shaped hollow for attaching the side supports to the eyewear frame.

Referring to FIG. 9, each of the ear stems 38 has a pivot end 44 which is coupled pivotally on the pivot portion 42 of a respective one of the hinge members 36 for pivoting movement about a vertical axis. The retaining portion 40 of the hinge member 36 is formed with a locking groove 46 for engaging removably the locking rib 35 formed on the engaging part 31 of the coupling member 30, when the retaining portion 40 of the hinge member 36 is fitted into the engaging space 32. If desired, another pair of rib and groove (not shown in the drawings) can be formed on the engaging part 31 and the hinge member 36, respectively, in an orientation different from that of locking rib 35 and locking groove 46 so as to ensure the multi-directional engagement between the hinge member 36 and the coupling member 30.

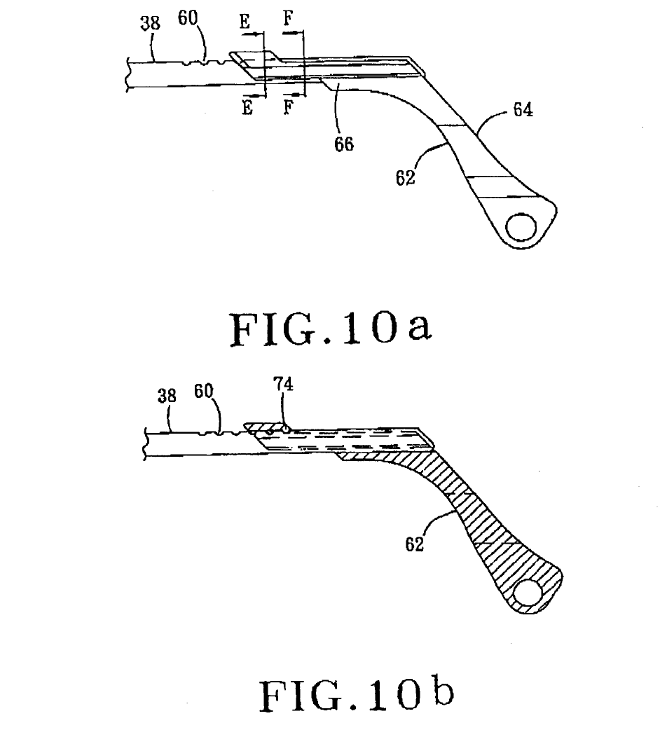

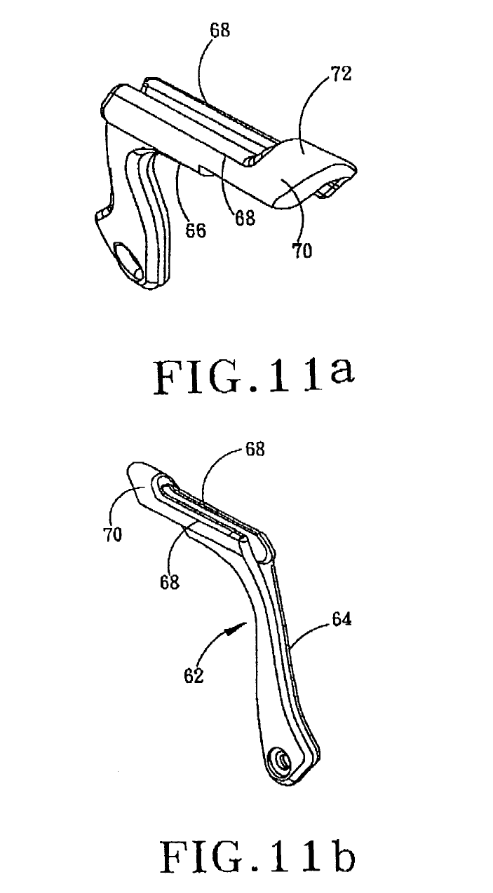

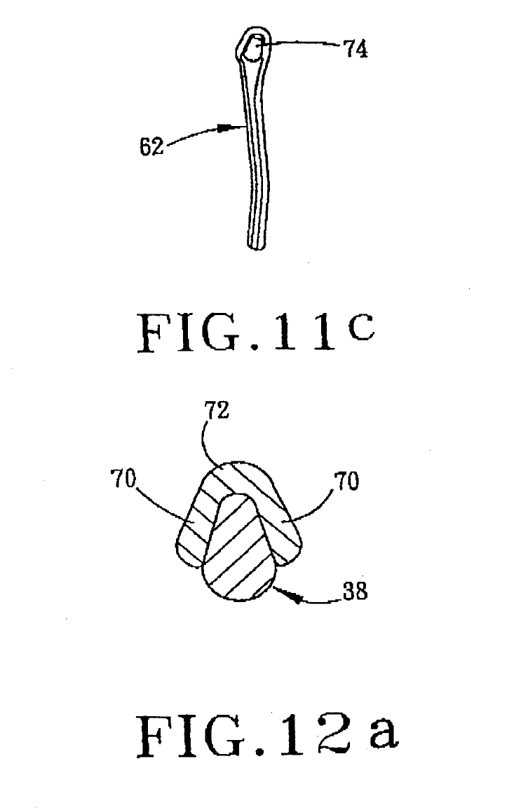

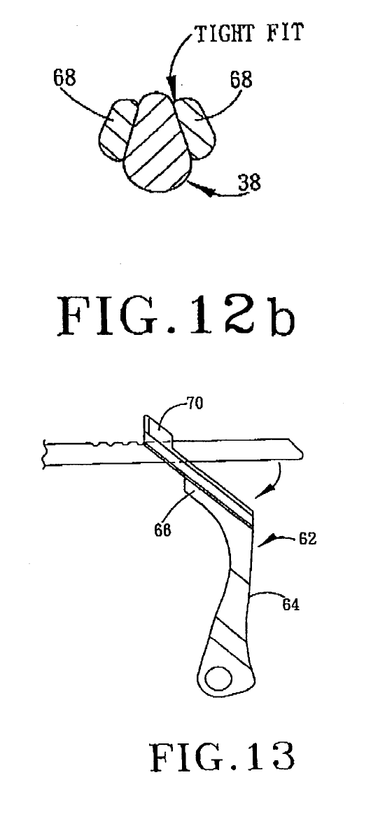

Another advantage of the eyeglasses 1 of this invention resides in easy adjustment of the effective length of the stem-type first side support 6. As clearly shown in FIG. 1, each of the elongated ear stems 38 has a series of positioning teeth 60 formed on a top edge of a support portion on which an earpiece 62 is mounted. Referring to FIGS. 10a, 10b, 11a, 11b, and 11c, the earpiece 62 includes an inclined leg portion 64, a bottom support portion 66 extending forwardly from the top end of the inclined leg portion 64, and a parallel pair of clamping rail portions 68 extending upwardly and forwardly from opposite lateral edges of the bottom support portion 66. The bottom support portion 66 is disposed adjacent to the bottom edge of the ear support portion of the ear stem 38. The parallel pair of clamping rail portions 68 flank the lateral sides of the ear support portion of the ear stem 38 and are in tight contact with the lateral sides of the ear support portion of the ear stem 38 as shown in FIGS. 12a and 12b. A parallel pair of arm portions 70 are connected to front ends of the clamping rail portions 68, respectively, and extend upwardly from and incline forwardly relative to the clamping rail portions 68. A bridge portion 72 interconnects top ends of the arm portions 70 and is disposed above the top edge of the ear support portion 45 of the ear stem 38.

As shown in FIG. 11c, a detent projection 74 is formed on the bridge portion 72 of each of the earpieces 62. FIG. 10b shows the engagement between the detent projection 74 of the earpiece 62 and the ear support portion of the ear stem 38. The detent projection 74 is provided inside the U shape created by the bridge portion 72 and the parallel pair of arm portions 70. The projection 74 suitably snaps in one of the notches defined by two adjacent teeth 60 so as to retain the earpiece 62 at a desired position on the ear support portion of the ear stem 38 and lock the sliding of the earpiece 62. Since the clamping rails 66 are in tight contact with the ear stem 38 and since the detent projection 74 engages a notch defined by two adjacent teeth 60, the earpiece 62 is hardly movable along the length of the ear stem 38 during normal use.

Referring to FIG. 13 where the operation of the earpiece 62 is illustrated, in order to adjust the effective length of the first side support 6, the earpieces 62 are first rotated downwardly so as to disengage the detent projection 74 from one of the engaging notches. Then, the earpieces 62 can be urged to move forward or backward along the length of the ear stem 38 to adjust the effective length of the ear stem 38. Because of the disengagement between the detent projection 74 and the notch, and because of the reduced friction force between the clamping rails 66 and the ear stem 38 due to the inclined orientation of the earpiece 62, it is possible to force the earpiece 62 to move along the length of the stem 38. Once the earpiece 62 has been moved to a position corresponding to a desired effective length of the first side support 6, the earpieces 62 are rotated upwardly so as to engage the detent projection 74 once again into a selected one of the notches defined by adjacent teeth 60.

Preferably, the earpiece 62 is formed integrally of a resilient plastic material, such as nylon zytel, and further includes an earpiece sock made from a cushioning material, such as monprene, and sheathed on the earpiece 62.

When the user or wearer of the eyeglasses mounted with the first side support 6 engages in vigorous activities, such as sports, the first side support 6 might be unable to hold the lens frame 2 tightly onto the wearer's head, thereby causing inconvenience to the wearer. In this case, a pair of eyeglasses with an elastic strap as an ear support might be desirable. The second side support 8 can substitute for the first side support 6 to satisfy the requirement of always holding the lens frame 2 tightly onto the wearer's head. Referring to FIG. 14, the second side support 8 includes a pair of strap fasteners 50 and a strap 52. As shown in FIGS. 15a and 15b, each of the strap fasteners 50 has a retaining portion 54 and a strap engaging portion 56. With the retaining portion 54 of each of the strap fasteners 50 inserted fittingly into the engaging space 32 of the respective one of the coupling members 30, the strap fasteners 50 are mounted detachably onto the lens retaining rims 10. The strap engaging portion 56, which is connected to the retaining portion 54 and disposed outwardly of the engaging space 32, is secured to the respective end of the strap 52 in a conventional manner.

It should be noted that since the engaging space 32 can be formed directly in the upper rim portion 18 of the lens retaining rims 10, it is possible for the strap fasteners 50 to be connected to the lens retaining rims 10 without using the coupling members 30.

While the strap fastener 50 is secured to the lens retaining rims 10 via the engaging part 31 of the coupling member 30 as mentioned above, the engagement between the lens retaining rims 10 and the strap fasteners 50 can be further secured with at least a pair of socket 56 and plug 60 provided on the lens retaining rims 10 and on the strap fastener 50, respectively. As shown in FIG. 15a in conjunction with FIG. 1, the outer lateral rim portion 14 of each of the lens retaining rims 10 is formed with three sockets 56, and the auxiliary mounting portion 58 of each of the strap fasteners 50 is formed with three plugs 60, which engage fittingly and removably the respective one of the sockets 56.

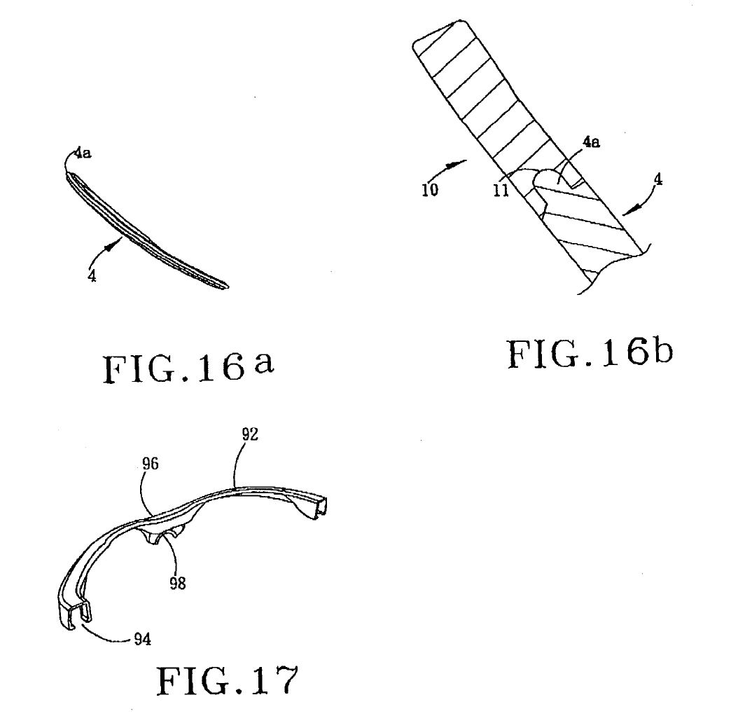

Referring to FIGS. 16a and 16b, the peripheral portion of each of the lenses 4 is formed with a skirt projection 4a having a thickness that is measured in a third direction transverse to the first and second directions and that is thinner than that of the lenses 4. The lens engaging inner periphery of each of the lens retaining rims 10 is formed with a peripheral groove 11 for engaging fittingly and removably the skirt projection 4a of the respective one the lenses 4, thereby mounting securely the lenses therein.

Preferably, the eyeglasses 1 further include a nosepiece 90 (shown in FIG. 1), which is made from a cushioning material such as silicone, and which is mounted on a rear side of the lens frame 2 at the lower sections of the inner lateral rim portions 12 and the lower section of the bridge 20.

Preferably, an impact cushioning band 92 made from a cushioning material, such as monprene, can be provided to absorb impact energy in case the eyeglasses 1 is subjected to an external impact. As shown in FIG. 17, the impact cushioning band 92 has a downwardly opening channel 94 which is elongated in the first direction. The upper rim portions 18 of the lens retaining rims 10 (or the coupling members 30, in case the coupling members 30 are provided) are fitted removably into the channel 94 of the impact cushioning band 92. An intermediate portion 96 of the impact cushioning band 92 adjacent to the bridge 20 has a bottom edge formed with a retaining projection 98 for engaging removably a bottom edge of the lower section 20b of the bridge 20. Thus, the impact cushioning band 92 can be mounted firmly onto the upper portions of the lens retaining rims 10. For fashion's sake, the impact cushioning band 92 can be made available in different colors.

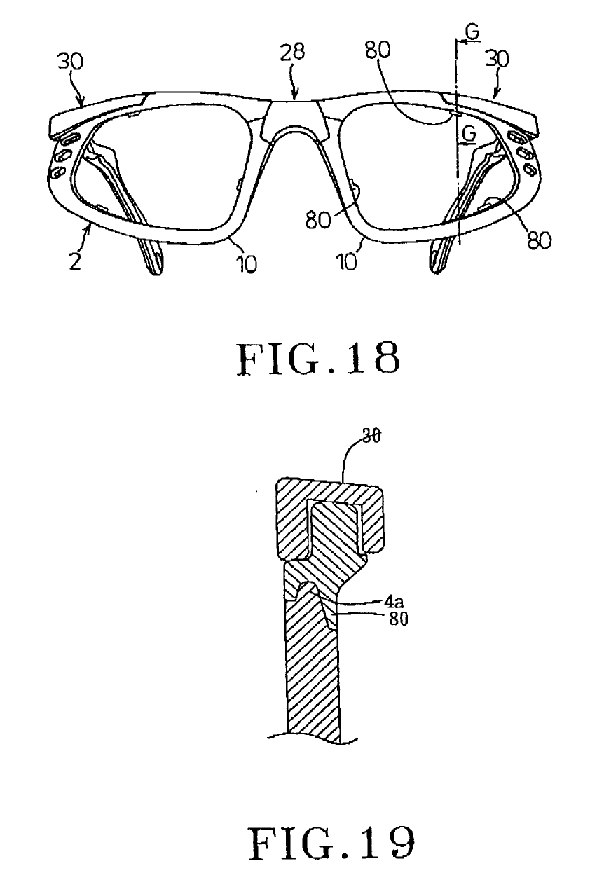

FIG. 18 shows a pair of eyeglasses of the second preferred embodiment of this invention. The eyeglasses 1 shown in FIG. 18 is substantially the same, in structure, as the one in the above-mentioned embodiment, except that three stop projections 80 are provided on the inner periphery of each of the lens retaining rims 10. As clearly shown in FIG. 19, the stop projections 80 are provided. on the inner periphery of the rims 10 at the rearward side adjacent to the wearer's eyes. The stop projections 80 extend radially and inwardly and abut against the skirt projection 4a at the rearward side, so as to prevent the lenses 4 from popping out of the lens frame 2 toward the user's eyes in the event of an external force which usually comes from the front side of the eyeglasses 1.

It will be appreciated that the number of the stop projections 80 is not limited to three and that the stop projections 80 can have various sizes and shapes as long as the stop projections 80 are provided on the rearward section of the inner periphery of the lens retaining rims 10.

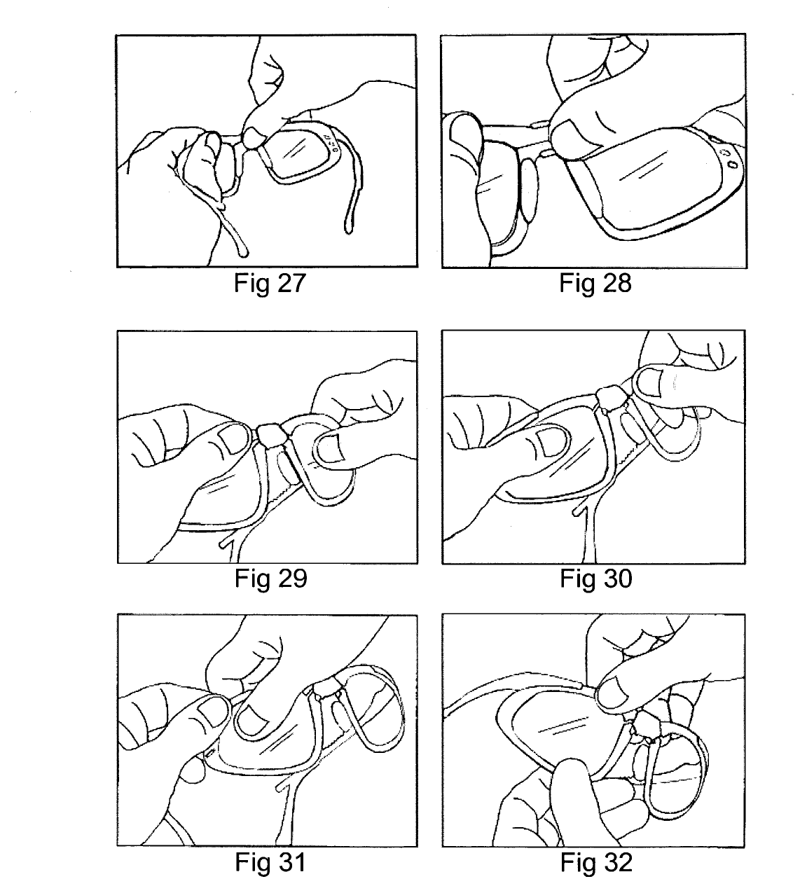

A method of changing lenses is detailed in FIGS. 27 to 36. Referring to FIG. 27, the lenses are held tightly in place by the vise-lock located at the bridge of the frame. To remove the lenses, the eyewear should be held firmly so that one is looking at the back (or inside of the glasses as shown in FIG. 27). The user should place a thumb on the vise-lock so that the user can feel the small notch that sticks out from the bottom of the bridge area.

Referring to FIG. 28, the user should, with a firm action, lever the vise-lock notch down and forward to ward the front (or outside) of the glasses as shown in FIG. 28. There is no need to completely remove the vise-lock. Simply ensure that it is released from the bottom of the bridge area so that the frame can separate slightly.

Referring to FIG. 29, the glasses should be turned around so that the front (or outside) of the glasses are facing the user as in FIG. 29. Now a little pressure is used to force the first lens out by pushing it forward (toward the user) from the top of the frame. The frame should be just loose enough to allow the lens to come free with a minimum of effort.

Referring to FIG. 30, this procedure should be repeated with the other lens shown in FIG. 30.

Referring to FIG. 31, to insert the new lens, eyewear is held as shown in FIG. 31 and the lens gently inserted by pressing the eyewear down and toward the bottom edge of the frame. The lenses have a narrow channel in their edges that is designed to fit snugly around the ridges on the inside of the eyewear frame.

Referring to FIG. 32, both hands push the lens toward the outside of the frame and into the ridge that holds it in place as shown in FIG. 32. Handle the eyewear with care at this point since the lens has still not been locked securely into position.

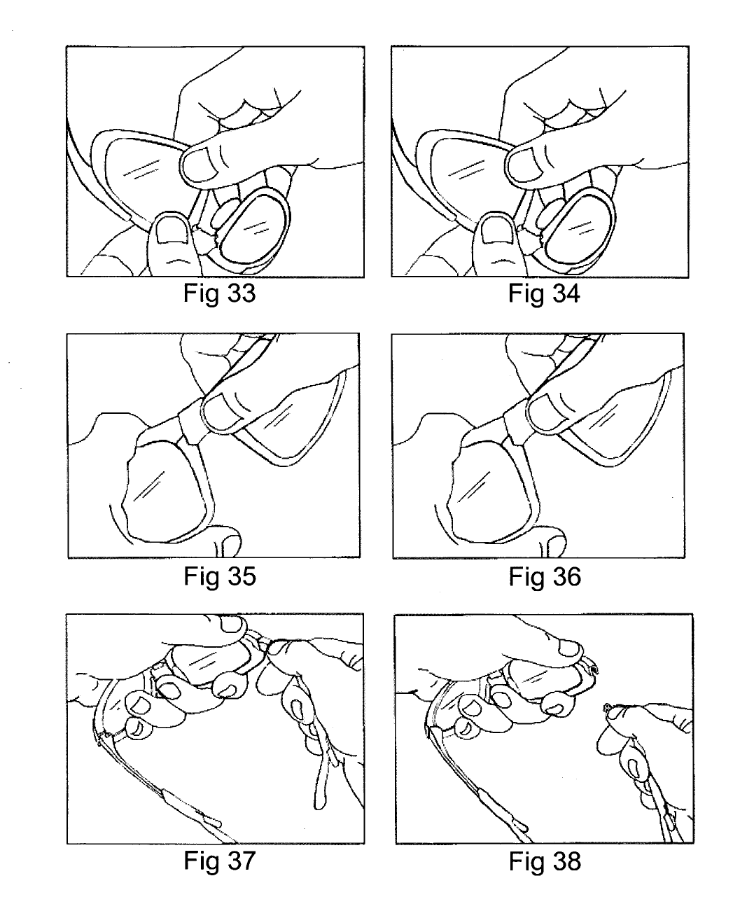

Referring to FIG. 33, the previous two steps are repeated with the other lens. The second lens is more easily inserted if the eyewear is turned upside-down as shown in FIG. 33. The bottom of the lens should be inserted first which means that the edge that appears at the top of FIG. 33 is inserted.

Referring to FIG. 34, the second lens is fit into place as with the first by using both hands to push the lens toward the outside of the frame and into the ridge that holds it in place as shown in FIG. 34. Caution should be used so as to not dislodge the first lens.

Referring to FIG. 35, the glasses are turned so that they are up the right way and the front (or outside) is facing the wearer as in FIG. 35. The lenses should be both fitted snugly into the frame by gently squeezing the top and bottom of the frame together with one hand.

Referring to FIG. 36, with a firm action, the thumb and forefinger of the other hand lever the vise-lock down and backward toward the bridge of the frame until it snaps into place as shown in FIG. 36. The eyewear lenses are now held securely.

FIGS. 37 to 42 illustrate a method of changing the side supports, namely the arms and the headband. Referring to FIG. 37, to remove the arms, the eyewear is firmly held so that the user is looking at the back (or inside) of the glasses as shown in FIG. 37. One of the arms is gripped tightly by the user's thumb and forefinger very close to the frame.

Referring to FIG. 38, the thumb pushes down firmly with until the arm snaps out of the locking slot as shown in FIG. 38. It may be necessary to wiggle the arm slightly to facilitate this with a new pair of eyewear. This procedure is repeated to remove the other arm.

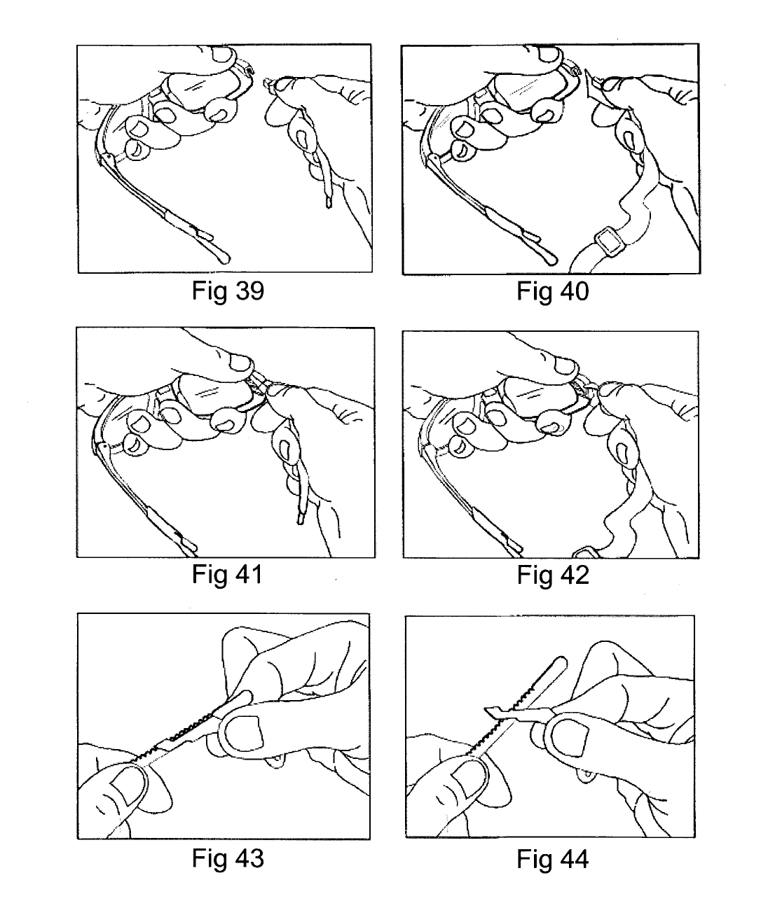

Referring to FIGS. 39 and 40, another arm or the headband with the side shields is inserted by simply reversing the procedure for removing them. This is begun by gripping the arm or the clip at the end of the headband between thumb and forefinger as shown in FIGS. 39 and 40. The piece is moved under the appropriate locking slot. If the headband is being installed, the side shield must be in front of the frame so that it will appear at the front of the glasses. It is important that the correct piece is used because the right and left arms and headband clips are not interchangeable.

Referring to FIGS. 41 and 42, the forefinger firmly pushes so that the arm or headband clip snaps into the locking slot as shown in FIGS. 41 and 42. This may require a little wiggling with the headband clip to ensure that it is aligned correctly. This procedure repeated with the other arm or headband clip.

FIGS. 43 to 46 illustrate adjustment of the microslot arms. Referring to FIG. 43, the Microslot arms are preferably adjusted while they are attached to the eyewear frame so that they can be tried on to get just the right fit. Begin by holding the base of the arm in one hand and the rubber earpiece in the other as shown in FIG. 43.

Referring to FIG. 44, thumb and forefinger are used to swing the earpiece down and toward the other hand as shown in FIG. 44.

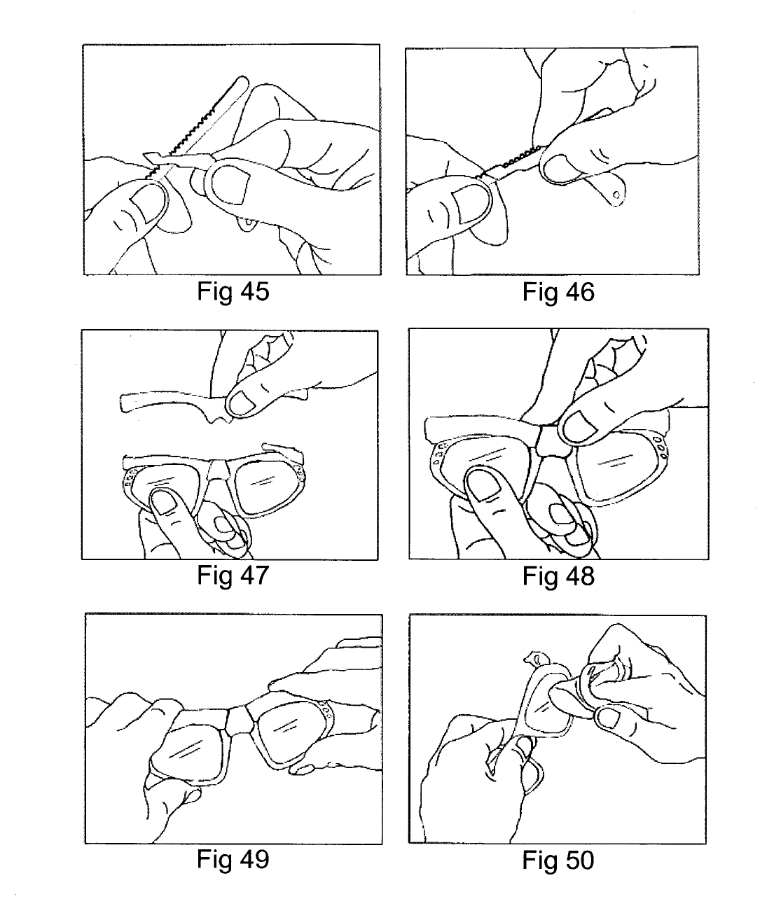

Referring to FIG. 45, the earpiece is slid backward or forward along the arm to the desired location.

Referring to FIG. 46, the earpiece is swung up and securely pinches the arm by use of thumb and forefinger as shown in FIG. 18. One can feel it lock into place. This procedure is repeated with the other Microslot arm. The user then tries the eyewear on and adjusts as necessary until the glasses fit securely and comfortably behind ears.

FIGS. 47 to 49 illustrate installation of the sport visor. Referring to FIG. 47, the user holds the eyewear so that the user is looking at the front (or outside) of the glasses as shown in FIG. 47. Thumb and forefinger press the sport visor down onto the center of the eyewear frame.

Referring to FIG. 48, the user presses down firmly on the sport visor so that it completely covers the vise-lock on the eyewear frame as shown in FIG. 48.

Referring to FIG. 49, both hands are used to squeeze the outer edges of the sport visor firmly onto the edges of the eyewear frame as shown in FIG. 49. The sport visor is removed by simply pull it up and away from the frame.

FIG. 50 illustrates cleaning of the lenses. Referring to FIG. 50, moisture or dust is cleaned from your eyewear lenses by gently wiping them using the microfiber cleaning mitt or other soft, lint-free cloth. The eyewear can also be washed using any mild soap and warm water. Solvents or abrasive cleaner should be avoided since this may damage the finish or scratch the lenses.

The prior art lens transfer vise-lock element can be difficult to remove when it is snugly secured onto the frame. The lens transfer vise-lock element is small and does not have a convenient feature for manual gripping by the user's fingers.

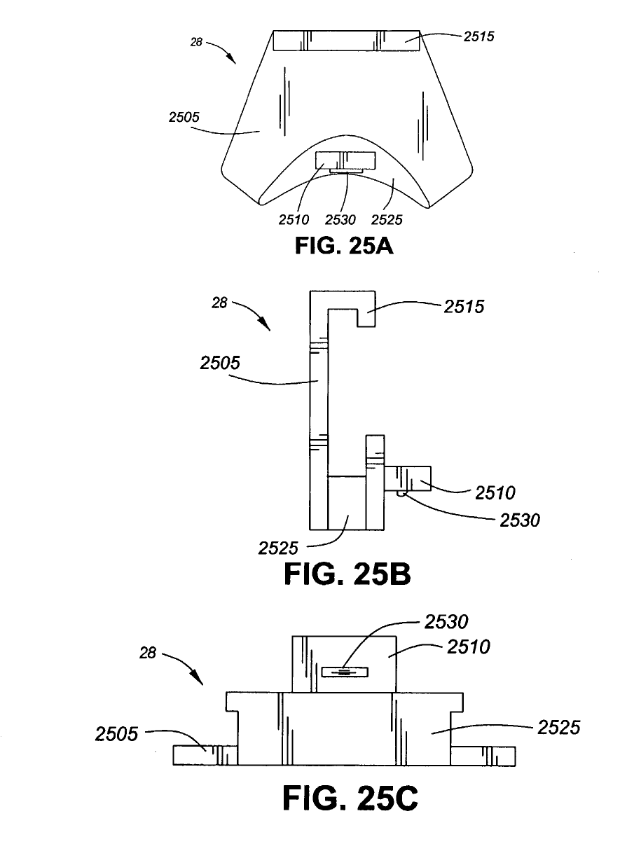

According to the present invention, the there is provided a locking element such as lens transfer vise-lock element 28 for clamping the bridge of the eyewear frame and preventing the lens frames from releasing the held lenses. The locking element has a “C” shaped cross-section as seen in FIG. 25b. The locking element including a planar main portion 2505, an upper portion relatively proximate to the nosepiece of the eyewear and a lower portion 2525 relatively distant from the nosepiece, a descending upper flange 2515 attached to the upper portion and a rising lower flange attached to the lower portion 2525.

A tab 2510 is provided on the rising lower flange. This tab serves three functions: providing a grip element for sure grip of the lens transfer vise-lock element by the user; serving as a lever to allow greater torque to be applied in removing the lens transfer vise-lock element from the bridge of the eyewear; and serving as a protrusion onto which the optical adapter can be mounted. The tab protrudes from the plane of the rising lower flange and extending away from the main portion. The tab allows the user to apply leverage by pulling on the end of the lever member. This causes the lens transfer vise-lock element to rotate about the top of the bridge, greatly facilitating the removal of the lens transfer vise-lock element from the frame. In addition, the user's grip is much more secure and the action of removing the lens transfer vise-lock element can be performed more surely. The tab is provided with a locking tooth 2530.

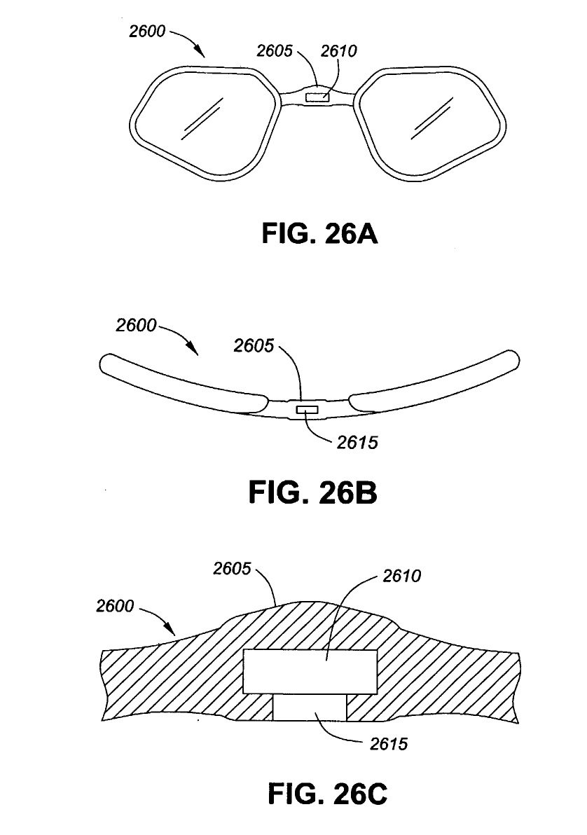

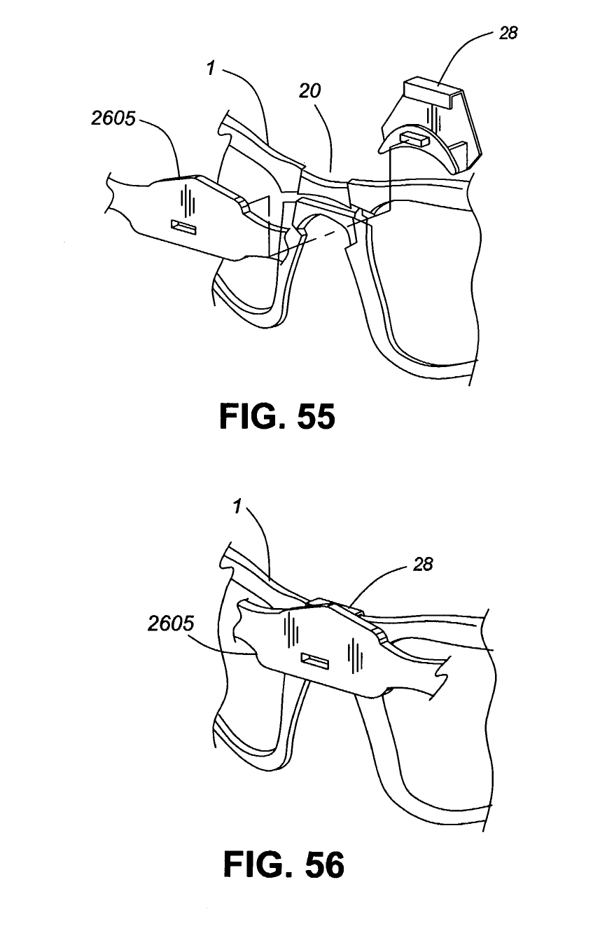

An optical adapter 2600 is illustrated in FIGS. 26a, 26b and 26c. The optical adaptor allows the user to use corrective lenses when wearing the eyewear of the present invention. The optical adaptor is fitted with prescription corrective lenses and mounted to the eyewear. The optical adapter includes a central bridge portion 2605 having slot 2610. The slot corresponds with the shape of the tab 2510. Referring to FIGS. 53 to 56, the optical adapter is mounted to the frame of the eyewear by orienting the frame of the optical adaptor to match that of the eyewear, placing the optical adapter behind the frame and seating the slot over the tab. Pressing on the bridge of the optical adapter while bracing the frame causes the slot to slide along the tab until the optical adapter abuts against the back of the frame. At this point, the optical adapter is securely mounted onto the frame. Preferably a locking tooth 2530 is provided on the tab for mating with the corresponding recess 2615 in the wall of the slot of the optical adaptor to provide a positive engagement. Preferably the locking tooth has a ramped portion to facilitate mounting of the optical adaptor.

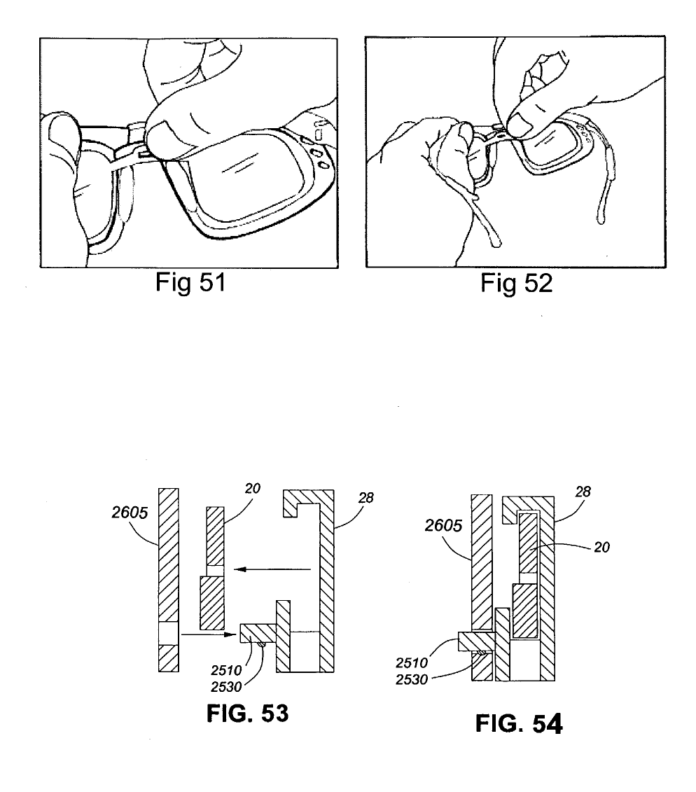

FIGS. 51 to 52 illustrate installation of the optical adaptor. Referring to FIG. 51, the optical adaptor is installed on the inside of the frame as shown in FIG. 51. The small rectangular hole at the center of the adaptor is placed over the corresponding notch on the vise-lock above the bridge area of the eyewear frame. The optical adaptor is then pressed down firmly using your thumb until the optical adaptor snaps into place.

Referring to FIG. 52, the optical adaptor is removed by gripping it with thumb and forefinger near the rectangular hole at the center as shown in FIG. 52. Pulling firmly on the adaptor separates it from the frame. Wiggling the adaptor slightly can facilitate removal. The optical adaptor is not fitted with prescription lenses. The optical adaptor comes with the blank lenses that must be replaced with lenses fitted to the user's prescription by a licensed optician. The optical adaptor can be fitted with prescription lenses for most people, however, people wearing bifocals or requiring very strong corrective lenses, will not be able to use the optical adaptor.

A typical embodiment of the eyewear system includes: a frame; light equalization lenses; limiter lenses; enhancer lenses; microslot adjustable arms; sport arms; sport visor; one or more lens transfer vise-lock elements; a headband with side shields; an adjustable neck and head strap; an optical adapter; a microfiber cleaning unit; and a storage case. Preferably the microfiber cleaning unit is in the form of a storage bag.

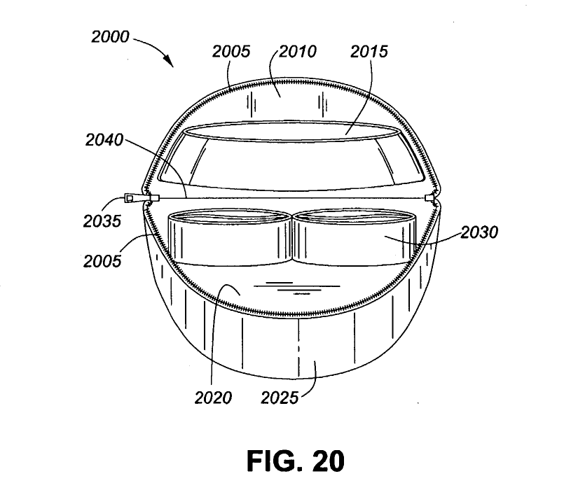

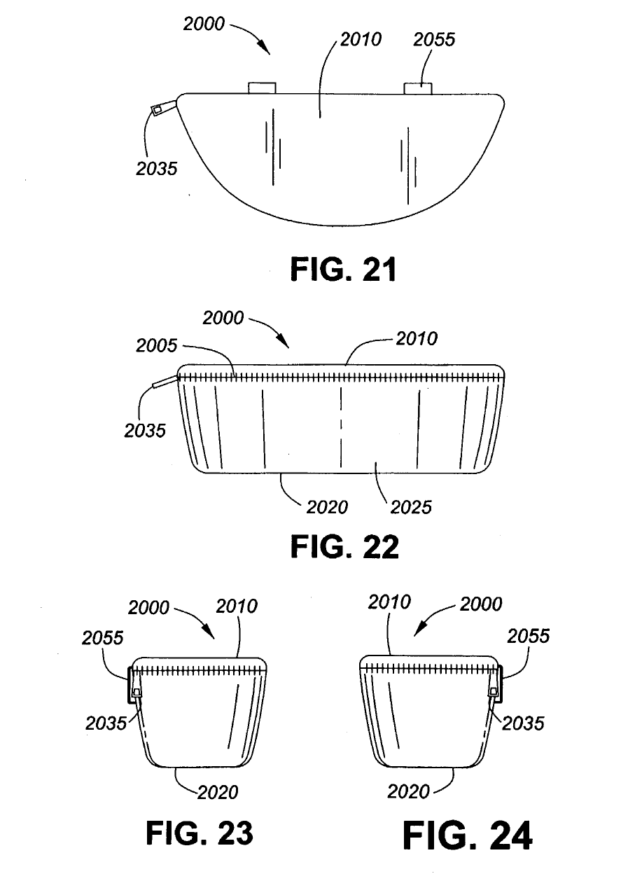

The eyewear system of the present invention affords many advantages not realized by conventional eyewear. In order to facilitate the easy use, storage and access to the different components, the system includes a storage container such as a portable compartmentalized carrying case. The case ensures that the components are easily accessible when desired for use and protects fragile components such as the different sets of lenses when in storage. Referring to FIGS. 20 to 23, the carrying case 2000 includes a bottom, a back wall 2020, a wrap around front wall 2025 and a lid 2010. The lid is hinged to the back wall along the fold 2040. A suitable fastener such as a zipper 2005 is provided to allow convenient and secure closure of the case. Loops 2055 provided on the outside of the back wall allow the carrying case to be belt-mounted. A lanyard clip (not shown) is provided to allow the case to be fastened to clothing. The size of the carrying case allows handy storage, for example, in a glove compartment of a car.

The case is dimensioned to fit the folded eyewear into the main compartment. The lid is provided with an elongated pouch 2015, which is wide enough to store the microslot adjustable arms or the sport arms. It is also suitable for storing smaller components such as extra lens transfer vise-lock elements. Mounted to the back wall of the case is a pair of dual pouches 2030. Each dual pouch is divided into two pockets. The pockets can be used to separate lenses from other components in the case thereby minimizing the possibility of breaking or scratching the lenses.

Additional elements such as the headband or the sport visor can be stored in the main compartment when not in use. For example, the eyewear configuration illustrated in FIG. 1 includes a frame, light equalization lenses, microslot adjustable arms, coupling members, and a lens transfer vise-lock element. The remaining elements which include the limiter lenses, the enhancer lenses, the sport arms, the sport visor, any remaining lens transfer vise-lock elements, the headband, the adjustable neck and head strap, the optical adapter and the microfiber cleaning unit can be stored in the case as follows. The limiter lenses and enhancer lenses are stored in the pockets of pouches 2030. The sport arms, additional lens transfer vise-lock elements, the optical adapter and microfiber cleaning unit are stored in the elongated pouch. Preferably the optical adapter is stored inside the microfiber storage bag. The headband, adaptable strap and sport visor can be stored in the main compartment, which has ample room to include the eyewear of FIG. 1 when not in use.

It should be understood that the above description is intended to be illustrative and not restrictive. A variety of modifications will be apparent to those skilled in the art within the sprit and scope of the invention as defined in the appended claims.

What is claimed is:

1. An eyewear system, comprising:
at least one pair of lenses;
an eyewear frame including a pair of lens frames, the lens frames connected by a bridge, each lens frame releasably holding a corresponding lens of the at least one pair of lenses;
a locking element for clamping the bridge of the eyewear frame and preventing the lens frames from releasing the held lenses;
the locking element having a “C” shaped cross-section, the locking element including a planar main portion, an upper portion relatively proximate to the nosepiece of the eyewear and a lower portion relatively distant from the nosepiece, a descending upper flange attached to the upper portion and a rising lower flange attached to the lower portion, and a tab provided on the rising lower flange, the tab protruding from the plane of the rising lower flange and extending away from the main portion, the tab serving as a grip for manual manipulation of the locking element by the user and serving as a lever when removing the locking element from the eyewear frame by rotating the locking element against an upper portion of the bridge of the eyewear frame;
at least one side support for holding the eyewear frame to a head of the user;
releasable mounting means for mounting the at least one side support to the eyewear frame; and
a nosepiece mounted to the frame for spacing the eyewear frame from a face of the user.

2. The eyewear system of claim 1, further comprising an optical adapter for holding corrective lenses between the eyewear frame and the eyes of the user, the optical adapter having a slot for receiving the tab for mounting the optical adapter to the lens frame.

3. The eyewear system of claim 2, wherein the tab further comprises a protruding locking tooth and the optical adapter has a corresponding recess located in a wall of the slot, the recess for receiving the protruding locking tooth.

4. The eyewear system of claim 1, wherein the at least one pair of lenses comprises: a pair of light equalization system lenses; a pair of enhancer lenses; and a pair of limiter lenses.

5. The eyewear system of claim 1, wherein at least one side support comprises: a pair of adjustable arms; a pair of sports arms and a headband.

6. The eyewear system of claim 1, further comprising a portable compartmentalized protective storage case.

7. The eyewear system of claim 6, wherein the storage case comprises: a bottom, a back wall, a wrap-around sidewall and a lid attached to the back wall, the back wall, the sidewall and the bottom defining a main compartment for storing the eyewear; and wherein the storage case further comprises a pair of dual pouches located in the main compartment, each dual pouch for storing a pair of lenses, each dual pouch comprising two pockets.

8. The eyewear system of claim 7, wherein an elongated compartment is provided in the lid for storing side supports.

9. The eyewear system of claim 1, wherein the eyewear frame is provided with a pair of coupling members, the coupling members mountable to the eyewear frame, each coupling member having an engaging space having planar sidewalls, elongate ribs provided on the planar sidewalls to define an “S”-shaped hollow in each coupling member and wherein the side supports include corresponding “S”-shaped complementary coupling members having planar sidewalls for frictional engagement with the “S”-shaped hollow for attaching the side supports to the eyewear frame.
